(19) United States
(12) Patent Application Publication
(10) Pub. No.: US 2012/0046154 A1
(43) Pub. Date: Feb. 23, 2012

(54) Sheet folding device, sheet processing device, image forming apparatus, and sheet folding method

(75) Inventors: Kazumasa Takeuchi, Aichi (JP); Mitsuru Ichikawa, Aichi (JP)

(73) Assignee: Ricoh Company, Limited, Tokyo (JP)

(21) Appl. No.: 13/137,321

(22) Filed: Aug. 5, 2011

(30) Foreign Application Priority Data
Aug. 17, 2010 (JP) 2010-182350

(51) Int. Cl. B31F 1/00

(52) U.S. Cl. 493/405

(57) ABSTRACT

A sheet folding device includes: a guide unit that bends a sheet or a sheet bundle in a direction perpendicular to a conveying direction and guides a bent portion into between two members facing each other; and a press-folding unit that presses to fold the bent portion, and a change controlling unit that performs control of changing a gap between the two members depending on a thickness of the sheet or the sheet bundle when the sheet or the sheet bundle is guided into between the two members.

### CROSS-REFERENCE TO RELATED APPLICATIONS

The present application claims priority to and incorporates by reference the entire contents of Japanese Patent Application No. 2010-182350 filed in Japan on Aug. 17, 2010.

### BACKGROUND OF THE INVENTION

1. Field of the Invention

The present invention relates to a sheet folding device performing a folding process on a sheet member (hereinafter, simply referred to as a “sheet”) such as paper, transfer paper, and film, a sheet processing device including the sheet folding device, an image forming apparatus such as a copying machine, a printer, a facsimile, and a digital multi-functional peripheral (MFP) including the sheet processing device, and a sheet folding method performed in the sheet folding device.

2. Description of the Related Art

In a so-called post-processing peripheral device performing a predetermined process on a sheet discharged from an image forming apparatus such as a copying machine, a plurality of sheets are saddle-stitched by a staple and then pressed by pressing rollers or pressing plates to be folded into two (hereinafter, referred to as a “saddle-stitching and folding”). This technique is already known as disclosed in, for example, Japanese Patent Application Laid-open No. 2009-1417 and Japanese Patent Application Laid-open No. 2010-6602.

Among them, Japanese Patent Application Laid-open No. 2009-1417 discloses a technique in which a gap between folding rollers and a gap between guide plates are made to be variable to prevent occurrence of wrinkles or a deviation in a folded position caused when a nip portion of the folding rollers is deviated from a center of a folded position of a sheet bundle. More specifically, Japanese Patent Application Laid-open No. 2009-1417 discloses a sheet post-processing device including: a first roller; a second roller that is biased to be movable close to and away from the first roller and forms a nip portion together with the first roller; a stacking unit that stacks a sheet bundle; a folding plate of which the front end butts the sheet bundle stacked on the stacking unit to move the sheet bundle toward the nip portion so that the sheet bundle is pushed into the nip portion; a first guide member that is fixed relative to the first roller, is located between the nip portion and a position, at which the folding plate butts the sheet bundle, and nearer to the first roller than a common tangent line of the first and second rollers at the nip portion, and guides the sheet bundle butted and pressed by the folding plate toward the nip portion; and a second guide member that is disposed between the nip portion and the position at which the folding plate butts the sheet bundle and nearer the second roller than the common tangent line, follows the movement of the second roller, and guides the sheet bundle butted and pressed by the folding plate toward the nip portion together with the first guide member.

Further, Japanese Patent Application Laid-open No. 2010-6602 discloses a saddle-stitching and folding device in which a pressing unit stops a sheet bundle folded into two at a predetermined position and presses a fold line of the stopped sheet bundle from the front and rear surfaces between pressing surfaces facing each other for the purpose of providing a saddle-stitching and folding device capable of making a booklet that is saddle-stitched and folded and is strongly creased in a short time. More specifically, Japanese Patent Application Laid-open No. 2010-6602 discloses a saddle-stitching and folding device including: an aligning and saddle-stitching unit that aligns a conveyed sheet bundle and saddle-stitches the center thereof in the conveying direction; a folding unit that is provided downstream of the aligning and saddle-stitching unit and folds the sheet bundle into two; a pressing unit that stops the sheet bundle folded into two at a predetermined position and applies a pressure to a fold line of the stopped sheet bundle from the front and rear surfaces between pressing surfaces facing each other; and a pressing times control unit that determines pressing times that is number of applying a pressure to the fold line of the sheet bundle in the pressing unit and controls the pressing unit such that the pressing process is performed as many as the determined number of times.

However, as disclosed in Japanese Patent Application Laid-open No. 2009-1417, even when the sheet bundle butted and pressed by the folding plate is guided to the nip portion by the second guide member, which follows the movement of the second roller, together with the first guide member, occurrence of deflection cannot be suppressed. For this reason, when the deflection occurs immediately before the sheet bundle is introduced into the nip portion of the folding roller (the first and second rollers), a position of the folding plate is deviated from a position at which the sheet bundle is saddle-stitched, so that the sheet bundle may not be folded at a correct position. Further, wrinkles may be generated due to this reason. Furthermore, since the pressure applied to the sheet bundle decreases compared to a case other than a case where the folding roller is movable to widen a gap of the nip portion of the folding rollers, an adequate pressure may not be applied to the sheet bundle. As a result, the sheet bundle may not be correctly creased. When the sheet bundle is not correctly creased, a height of the folded saddle-stitched booklet increases, so that the appearance of the booklet is spoiled and stack performance of the booklet on a stacking tray is decreased.

On the other hand, in the invention disclosed in Japanese Patent Application Laid-open No. 2010-6602, since the sheet bundle folded into two in the folding unit is folded again in the pressing unit, if a fold line first formed in the folding unit is deviated from a fold line formed in the pressing unit, folding into a box-like configuration or a folding error may occur. conveying roller

### SUMMARY OF THE INVENTION

It is an object of the present invention to at least partially solve the problems in the conventional technology.

According to an aspect of the present invention, there is provided a sheet folding device including: a guide unit that bends a sheet or a sheet bundle in a direction perpendicular to a conveying direction and guides a bent portion into between two members facing each other; a press-folding unit that presses to fold the bent portion; and a change controlling unit that performs control of changing a gap between the two members depending on a thickness of the sheet or the sheet bundle when the sheet or the sheet bundle is guided into between the two members.

According to another aspect of the present invention, there is provided a sheet folding method including: bending a sheet or a sheet bundle in a direction perpendicular to a conveying direction and guiding the bent portion into between two members facing each other; presses to fold the bent portion; and performing control of changing a gap between the two members depending on a thickness of the sheet or the sheet bundle in order to suppress deflection of the bent portion when the sheet or the sheet bundle is guided into between the two members.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a system configuration of an image forming apparatus according to an embodiment of the invention;

FIG. 2 is a perspective view illustrating a press-folding unit in FIG. 1;

FIG. 3 is a front view when the press-folding unit of FIG. 2 is seen from the front side of the apparatus;

FIG. 4 is a diagram illustrating a state of the press-folding unit in which a pressing plate driving cam, a folding blade driving cam, and a side plate are excluded from the state of FIG. 2;

FIG. 5 is a front view when FIG. 4 is seen from the front side of the apparatus;

FIG. 6 is a perspective view illustrating the press-folding unit in which the moving plate is excluded from the state of FIG. 4;

FIG. 7 is a front view when a dotted line portion H of FIG. 6 is enlarged and seen from the front side of the apparatus;

FIG. 8 is a diagram illustrating the inside of a pressing unit in FIG. 4;

FIG. 9 is a front view when the pressing unit of FIG. 8 is seen from the front side of the apparatus;

FIG. 10 is a diagram illustrating a series of press-folding process and occurrence of deflection of the sheet bundle, and illustrates a state immediately before the center-folding process is performed after the sheet bundle is located at a center-folding position in a fourth conveying path;

FIG. 11 is a diagram illustrating a series of press-folding process and occurrence of deflection of the sheet bundle, and illustrates a state where the sheet bundle is pushed in by a folding blade into a nip portion of a pair of conveying rollers in the direction perpendicular to the sheet bundle;

FIG. 12 is a diagram illustrating a series of press-folding process and occurrence of deflection of the sheet bundle, and illustrates a state where the sheet bundle is conveyed by the conveying roller so that the front end of the sheet bundle is located before a folding position of pressing plates;

FIG. 13 is a diagram illustrating a series of press-folding process and occurrence of deflection of the sheet bundle, and illustrates a state where the sheet bundle is pressed by the pressing plates so that the front end of the sheet bundle passes the folding position of the pressing plates;

FIG. 14 is a diagram illustrating a press-folding example according to a first embodiment, and illustrates a state where the sheet bundle is bent and extruded in the direction perpendicular to the conveying direction of the sheet bundle from an opening of a fourth conveying path;

FIG. 15 is a diagram illustrating a press-folding example according to the first embodiment, and illustrates a state where the front end of the sheet bundle is located before the folding position of the pressing plates from the state of FIG. 14;

FIG. 16 is a diagram illustrating a press-folding example according to the first embodiment, and illustrates a state where the sheet bundle is pressed by the pressing plates for a folding process thereon;

FIG. 17 is a diagram illustrating a press-folding example according to the first embodiment, and illustrates a state where the folding process of FIG. 16 is ended, the pressing plates move away from each other, and the sheet bundle is further conveyed downstream;

FIG. 18 is a diagram illustrating a press-folding example according to the first embodiment, and illustrates a state where an extracting bar is inserted into the sheet bundle and is conveyed by applying a conveying force from a backside of the front end;

FIG. 19 is a diagram illustrating a press-folding example according to a second embodiment, and illustrates a state where the sheet bundle is conveyed to a folding position by a pair of conveying rollers and a folding blade;

FIG. 20 is a diagram illustrating a press-folding example according to the second embodiment, and illustrates a state where the sheet bundle conveyed by the pair of conveying rollers and the folding blade is press-folded;

FIG. 21 is a diagram illustrating a press-folding example according to a third embodiment, and illustrates a state where the sheet bundle is conveyed to the folding position by the pair of conveying rollers and the folding blade;

FIG. 22 is a diagram illustrating a press-folding example according to a third embodiment, and illustrates a state where the sheet bundled conveyed by the pair of conveying rollers and the folding blade is press-folded;

FIG. 23 is a block diagram illustrating a control configuration of a sheet post-processing device that controls change of the gap between the pressing plates in the third embodiment;

FIG. 24 is a diagram illustrating a press-folding example according to a fourth embodiment, and illustrates a state immediately before a center-folding process is performed after the sheet bundle is located at a center-folding position in a fourth conveying path;

FIG. 25 is a diagram illustrating a press-folding example according to the fourth embodiment, and illustrates a state where the sheet bundle is pushed in by the folding blade between the pair of conveying rollers, which move away from each other, in the direction perpendicular to the sheet bundle;

FIG. 26 is a diagram illustrating a press-folding example according to the fourth embodiment, and illustrates a state where the front end of the sheet bundle is conveyed downstream of a nip position of the pair of conveying rollers and the pair of conveying rollers conveys the sheet bundle therebetween;

FIG. 27 is a diagram illustrating a press-folding example according to the fourth embodiment, and illustrates a state where the front end of the sheet bundle reaches the folding position of the pressing plates and is press-folded by the pressing plates;

FIG. 28 is a diagram illustrating a press-folding example according to the fourth embodiment, and illustrates a state where the press-folding process is ended and the pressing plates move away from each other;

FIG. 29 is a diagram illustrating a press-folding example according to a fifth embodiment, and illustrates a state where the sheet bundle is bent and extruded in the direction perpendicular to the conveying direction of the sheet bundle from the opening in the fourth conveying path so that it is located between the conveying rollers moving away from each other;

FIG. 30 is a diagram illustrating a press-folding example according to the fifth embodiment, and illustrates a state where the front end of the sheet bundle reaches downstream of the nip position of the pair of conveying rollers from the state of FIG. 29 and the pair of conveying rollers conveys the sheet bundle therebetween;

FIG. 31 is a diagram illustrating a press-folding example according to the fifth embodiment, and illustrates a state where the front end of the sheet bundle reaches the folding position of the pressing plates from the state of FIG. 30 and is press-folded;

FIG. 32 is a diagram illustrating a press-folding example according to the fifth embodiment, and illustrates a state where the press-folding process is ended and the pressing plates move away from each other; and

FIG. 33 is a block diagram illustrating a control configuration of a sheet post-processing device that controls change of a gap between a pair of conveying rollers in the fifth embodiment.

### DETAILED DESCRIPTION OF THE PREFERRED EMBODIMENTS

In the embodiments to described below, a sheet corresponds to a reference numeral P, a sheet bundle corresponds to a reference numeral PB, a deflection portion corresponds to deflection PB, a press-folding unit corresponds to a center-folding unit 102 including an upper pressing unit 217, a lower pressing unit 218, a pressing plate driving cam 201, pressing guide rollers 211 and 212, and pressure releasing cams 209 and 210, a change controlling unit corresponds to a CPU 301, a pressing plate gap change controlling unit 303, and a conveying roller gap change controlling unit 305, a pair of pressing plates corresponds to pressing plates 219 and 220, a pair of conveying rollers corresponds to conveying rollers 206 and 207, a folding blade corresponds to a reference numeral 203, a folding position corresponds to a position where the pressing plates 219 and 220 come into contact with the sheet or the sheet bundle to apply a pressure thereto (corresponding to a moving range of pressing guide rollers 211 and 212), stoppers correspond to reference numerals 250 and 251, a thickness detecting unit corresponds to a sheet thickness detecting sensor 304, a counting unit corresponds to an entrance sensor 13 and a counter, an external apparatus corresponds to an image forming apparatus PR, a communication unit corresponds to a communication unit 301a, a sheet folding device corresponds to a reference numeral 100, and an image forming apparatus corresponds to a reference numeral PR.

Hereinafter, embodiments of the invention will be described with reference to the accompanying drawings. In explanation below, the same reference numerals will be given to the same components or the equivalent components, and redundant explanation of such components will be suitably omitted.

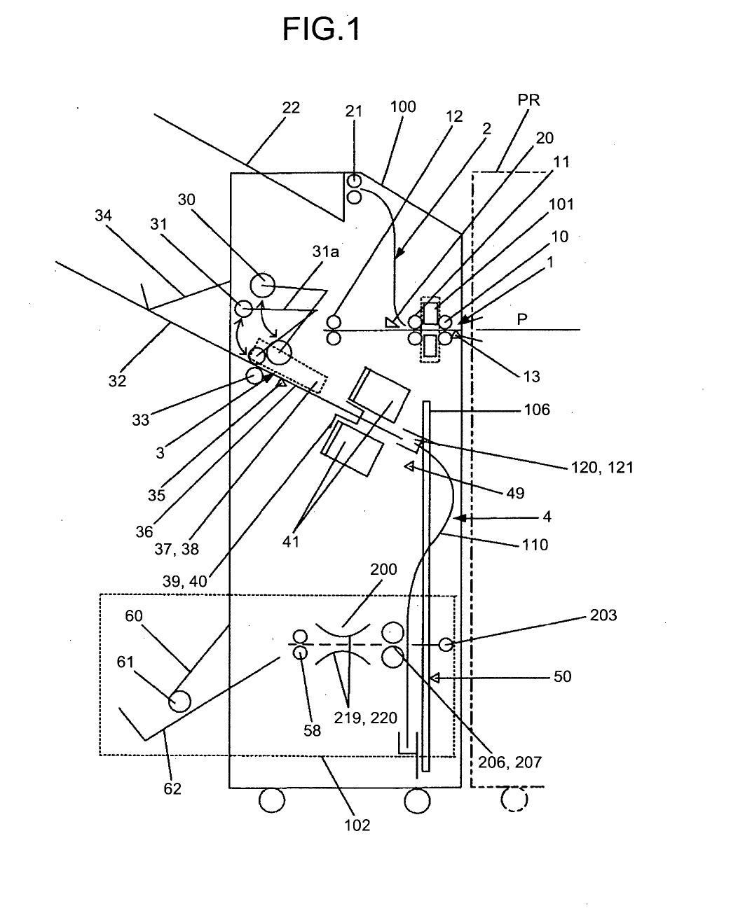

FIG. 1 is a diagram illustrating a system configuration of an image forming apparatus according to the embodiment. The image forming apparatus according to the embodiment includes an image forming apparatus PR and a sheet post-processing device 100 that serves as a sheet processing device installed after the image forming apparatus PR. The image forming apparatus PR includes an image forming unit (not shown) that forms an image by, for example, an electrophotography process and a feed unit that supplies a sheet to the image forming unit, and the image forming apparatus has a function of printing or forming an image on the sheet based on information transmitted from a personal computer PC, information read by a scanner, and information stored on a hard disk inside the image forming apparatus PR. As the image forming unit, a known image forming unit other than the electrophotography process type including a liquid ejecting type such as an inkjet type or a thermal type may be used.

The sheet post-processing device 100 includes a first conveying path (an entrance conveying path) 1 to receive a sheet P having an image formed thereon and discharged from the image forming apparatus PR, a second conveying path 2 to stack the sheet P on a discharge tray 22, a third conveying path 3 to intermediately stack the sheet P, and a fourth conveying path 4 to convey a sheet bundle, which is saddle-stitched at the center of the sheet in the longitudinal direction in the third conveying path 3, to a sheet folding unit.

The first conveying path 1 is provided with an entrance roller 10 and an entrance sensor 13, and the entrance sensor 13 detects whether the sheet P is conveyed into the sheet post-processing device 100. A sheet punching unit 101 is installed downstream of the entrance roller 10, first and second conveying rollers 11 and 12 are disposed in this order downstream of the sheet punching unit 101 along a conveying direction, and the sheet P is conveyed to the third conveying path 3 by the first and the second conveying rollers 11 and 12.

The second conveying path 2 is a path to convey the sheet P to the discharge tray 22 and is branched upward from the first conveying path 1, and a branching claw 20 is provided at a branching position. The sheet P, of which an advancing direction is changed from the first conveying path 1 by the branching claw 20, is conveyed from the first conveying roller 11 to the discharge tray 22 through a discharging roller 21. The discharge tray 22 is also referred to as a proof tray.

The third conveying path 3 is provided with a discharge driven roller 31, a discharge driving roller 33 and a discharging sensor 35. In a sorting mode, a second conveying roller 12 with a shifting mechanism is moved by a driving unit (not shown) by a predetermined amount in a direction perpendicular to a conveying direction during a conveying operation so that the sheet P is shifted by a predetermined amount, and the sheet P is discharged by a discharge driving roller 33 to a discharge tray 32 to be sequentially stacked thereon. At a discharge port to the discharge tray 32, the sheet P or a sheet bundle is nipped by the discharge driving roller 33 and the discharge driven roller 31, and is applied with a conveying force to be discharged. In this discharging operation, a closed state, in which the sheet P or the sheet bundle is nipped so that the sheet P or the sheet bundle can be discharged, or an opened state, in which the sheet P or the sheet bundle is not nipped can be selectively established by moving a discharge guide 31a with the discharge driven roller 31 close to or away from the discharge driving roller 33. After the operation of shifting the sheet P is completed, the discharge guide 31a is operated to nip the sheet between the discharge driven roller 31 and the discharge driving roller 33, so that the sheet P is discharged to the discharge tray 32.

A feeler 34 is provided near and above the discharge port, and a base end of the feeler 34 is rotatably attached to the sheet post-processing device 100 so that a front end of the feeler 34 comes into contact with an approximate center of the sheet P when the sheet P is stacked on the discharge tray 32. A top surface detecting sensor (not shown) is provided near the base end of the feeler 34 to detect a height position of the front end of the feeler 34, whereby a height of the stacked sheet P is detected.

When the top surface detecting sensor is turned on as the height of sheets increases as a result of increase of number of sheets staked on the discharge tray 32, a control unit (not shown) controls a driving unit (not shown) to move the discharge tray 32 up and down so that the discharge tray 32 moves down. When the tray moves down and the top surface detecting sensor is turned off, downward movement of the tray 32 is stopped. When the tray 32 reaches a predetermined tray full height by repeating this operation, a stop signal is output from the sheet post-processing device 100 to the image forming apparatus PR, so that image forming operation of the image forming apparatus PR is stopped.

The third conveying path 3 is provided with a stapling tray 36 and a tapping roller 30, and is provided, at an end position of the third conveying path 3, with a stapler 41 that is segmented into a driver and a clincher and that moves in a reciprocating manner in a direction perpendicular to the surface of FIG. 1. Furthermore, the third conveying path 3 is provided, at a position before the end position, with jogger fences 37 and 38 that move in a reciprocating manner in a direction perpendicular to a surface of FIG. 1 to align the sheets P on the stapling tray 36. The sheet conveyed to the conveying path 3 is discharged onto the stapling tray 36 and is aligned in a width direction by the jogger fences 37 and 38.

Further, the tapping roller 30 moves in a pendulum motion to come into contact with a top surface of the sheet to switch back the sheet toward the stapler 41 to cause a rear end of the sheet to abut on reference fences 39 and 40 to align a position of the sheet bundle in a longitudinal direction thereof (a position in the conveying direction). In an end-stitching mode, the stapler 41 moves in a direction perpendicular to a surface of FIG. 1 and staples the sheet bundle PB at appropriate positions of a lower edge the sheet bundle PB so that the sheet bundle PB aligned in this manner is stitched, and the sheet bundle PB is nipped and applied with a conveying force by the discharge driven roller 31 and the discharge driving roller 33, and is discharged onto the discharge tray 32.

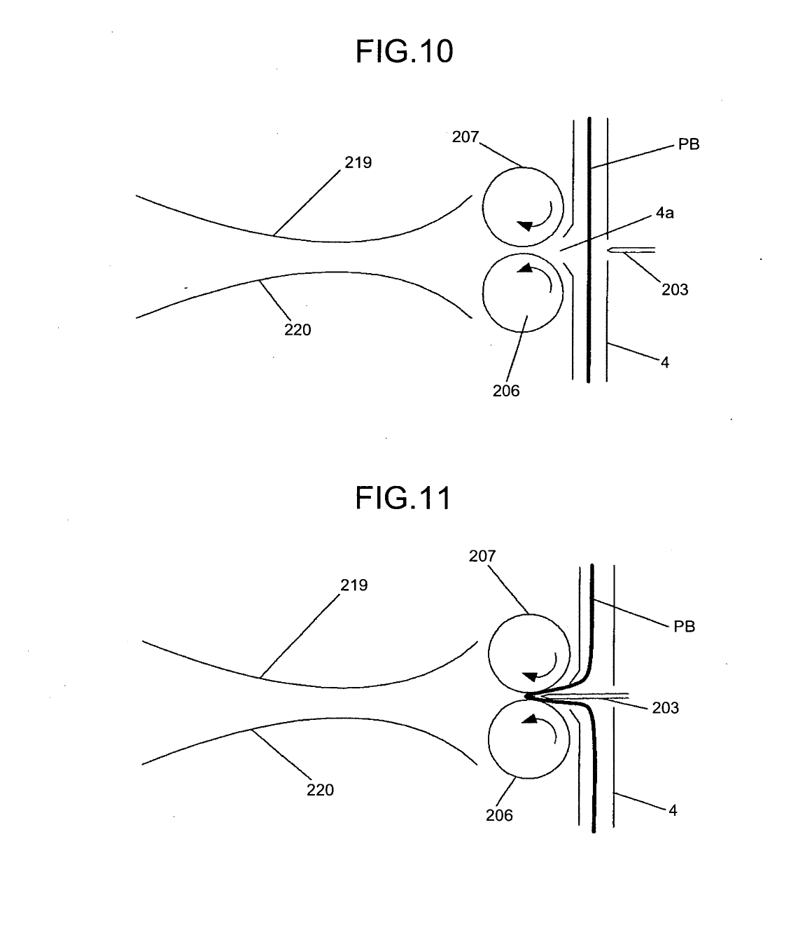

In a saddle-stitching mode, after alignment and stapling of the sheet P or the sheet bundle PB (see FIG. 10) is finished, the rear end of the sheet P or the sheet bundle PB is nipped by clamp moving fences 120 and 121, and the reference fences 39 and 40 escape outward in a sheet width direction so as not to disturb operation of conveying the sheet bundle PB. The clamp moving fences 120 and 121 are attached to a clamp longitudinal shaft 106 disposed out of an apparatus side plate so that the clamp moving fences 120 and 121 moves in a longitudinal direction (a vertical direction) while moving in a lateral direction (a horizontal direction) along the curved fourth conveying path 4.

The clamp moving fences 120 and 121 is moved in the longitudinal direction by the clamp longitudinal shaft 106, and is moved in the lateral direction by being caused to follow a guide rail 110 located at the apparatus side plate and having the same track as a curved track of the fourth conveying path 4, whereby the sheet P or the sheet bundle PB is conveyed along the fourth conveying path 4. The sheet or the sheet bundle PB of which a rear end is nipped is conveyed along the track of the guide rail 110 to a predetermined position depending on size of the sheet so that an appropriate position of a center portion of the sheet bundle in the length direction thereof is stapled and thereby the sheet bundle is saddle-stitched. The predetermined position depending on the size of the sheet is a position at a time when a predetermined number of pulses are sent after the clamp moving fences 120, 121 start from a position of a clamp moving fence home position sensor 49.

The sheet P or the saddle-stitched sheet bundle PB is further conveyed downward by the clamp moving fences 120 and 121, and is stopped at a position where the center portion of the sheet bundle in the length direction reaches a position of a folding blade 203. Then, a folding process is performed. The stop position is a position at a time when a predetermined number of pulses depending on the size of the sheet are sent after the rear end of the sheet is detected by a folding position sensor 50. Subsequently, the center portion of the sheet bundle in the length direction thereof stopped at the position for folding is introduced into a press-folding unit 200 by the folding blade 203 and the conveying rollers 206 and 207.

The press-folding unit 200 folds the center portion of the introduced sheet bundle in the length direction thereof by pressing the center portion from above and below by pressing plates 219 and 220. The sheet P or sheet bundle PB that has been center-folded is discharged onto a saddle-stitching tray 62 by conveying rollers 206 and 207 and a discharging roller 58.

The sheet P or the sheet bundle PB discharged onto the saddle-stitching tray 62 is pressed by a sheet pressing roller 61 attached to a sheet pressing member 60 so as not to disturb operation of discharging a sheet discharged next by swelling of the folded sheet.

The sheet punching unit 101 and a center-folding unit 102 with the fourth conveying path 4 are configured to be attachable and detachable, making it possible to provide a sheet post-processing device configured in accordance with a demand of a user. Incidentally, in the present embodiment, the center-folding unit 102 serves as a sheet folding device.

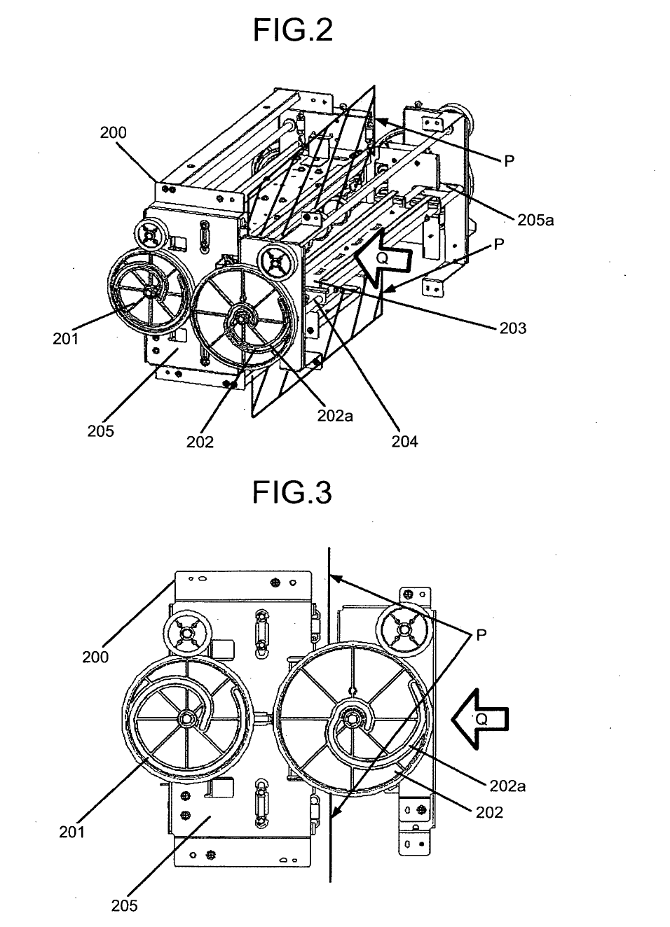

FIG. 2 is a perspective view illustrating the press-folding unit, and FIG. 3 is a front view when the press-folding unit is seen from the front side of the apparatus. The press-folding unit 200 is provided in the center-folding unit 102, and includes a pressing plate driving cam 201, a folding blade driving cam 202, a folding blade 203, a folding blade support bar 204, and front and rear side plates 205. When the folding blade driving cam 202 rotates, the folding blade support bar 204 horizontally moves along a horizontal groove 205a due to a relation between rotation of the cam idly fitted into a groove 202a and the horizontal groove 205a of the side plate 205, and the folding blade 203 moves in a direction depicted by an arrow Q. Accordingly, the sheet P or the center portion of the sheet P in the length direction thereof is guided to the folding unit.

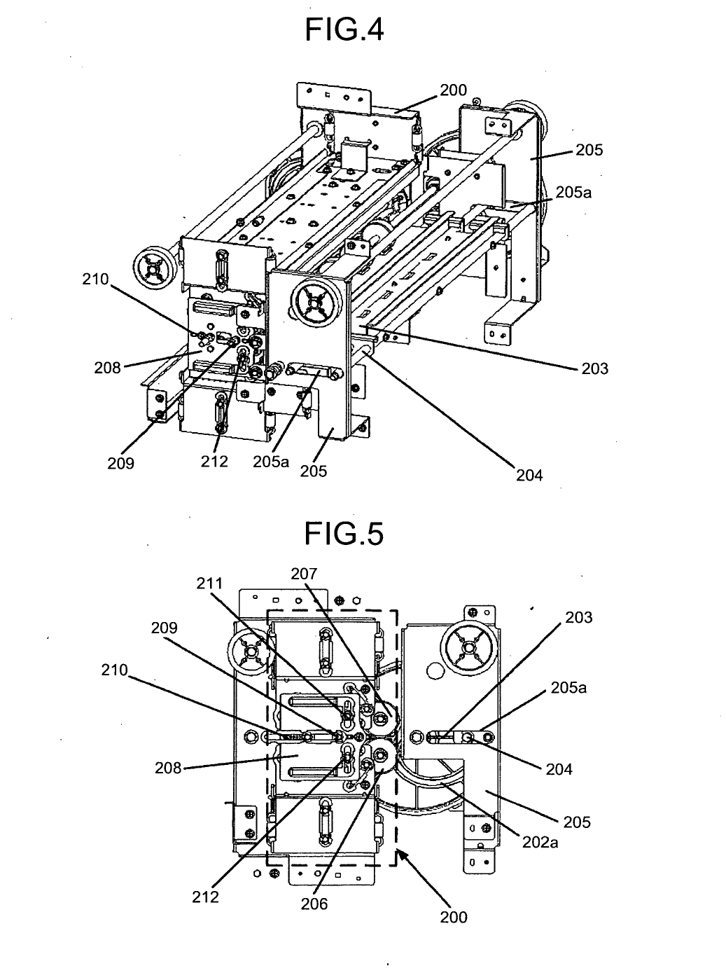

FIG. 4 is a diagram illustrating a state where the pressing plate driving cam 201, the folding blade driving cam 202, and the side plate 205 are excluded from the state of FIG. 2, and FIG. 5 is a front view when FIG. 4 is seen from the front side of the apparatus.

The press-folding unit 200 includes conveying rollers 206 and 207, a moving plate 208, pressing guide rollers 211 and 212, and pressure releasing cams 209 and 210. The folded front end of the sheet bundle PB or the sheet P introduced into the folding unit by the folding blade 203 is conveyed to the pressing unit by the conveying rollers 206 and 207. By movement of the moving plate 208, the pressing guide rollers 211 and 212 and the pressure releasing cams 209 and 210 connected to the moving plate 208 can be moved in a reciprocating manner in the sheet conveying direction.

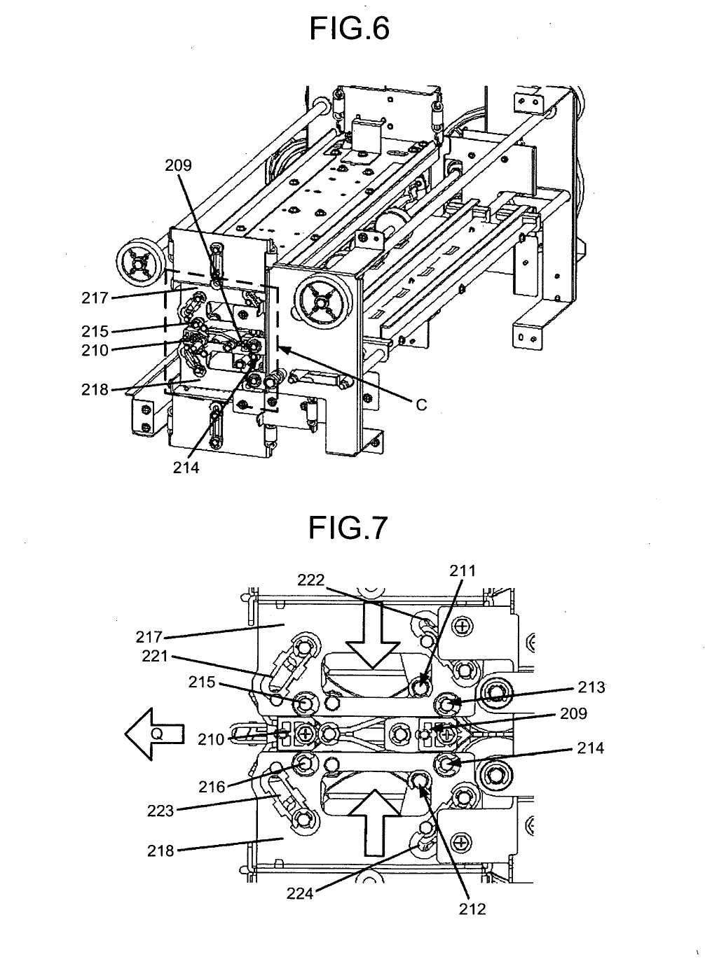

FIG. 6 is a perspective view illustrating a state where the moving plate 208 is excluded from the state of FIG. 4, and FIG. 7 is a front view when the dotted line portion C of FIG. 6 is enlarged and seen from the front side of the apparatus.

In FIGS. 6 and 7, in an upper pressing unit 217 and a lower pressing unit 218 respectively located at upper and lower positions with a sheet conveying path interposed therebetween, a pressure is applied to four corners of each unit by springs. In a standby state, the upper pressing unit 217 and the lower pressing unit 218 are moved away from each other by the pressure releasing cams 209 and 210 provided inside the press moving plate 208, and are ready for receiving the folded front end of the sheet bundle PB in this state.

When the moving plate 208 moves in the direction depicted by the arrow Q (FIG. 7), the pressure releasing cams 209 and 210 connected to the moving plate 208 move, and pressure releasing rollers 213 and 215 of the upper pressing unit 217 and pressure releasing rollers 214 and 216 of the lower pressing unit 218 move in directions depicted by arrows A and B due to slopes of the pressure releasing cams 209 and 210, so that the folded portion of the sheet bundle PB is pressed.

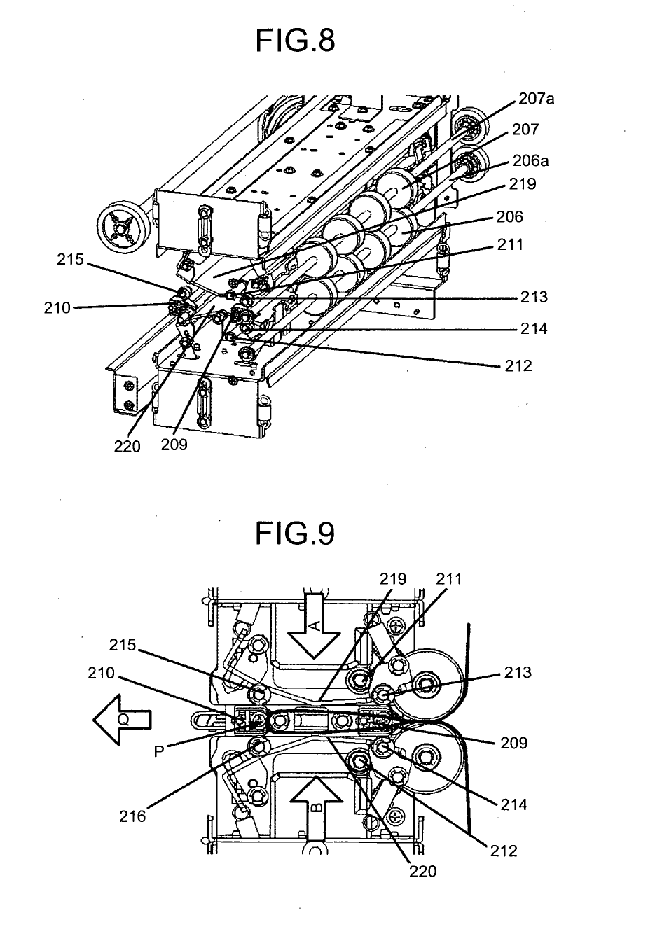

FIG. 8 is a diagram illustrating the inside of the pressing unit of FIG. 4, and FIG. 9 is a front view when FIG. 8 is seen from the front side of the apparatus.

In FIGS. 8 and 9, an upper pressing plate 219 and a lower pressing plate 220 are respectively provided in the upper pressing unit 217 and the lower pressing unit 218 inside the pressing unit, and the upper pressing plate 219 moves in the direction depicted by the arrow A and the lower pressing plate 220 moves in the direction depicted by the arrow B together with the upper and lower pressing units 217 and 218 in accordance with movement of the pressure releasing cams 209 and 210. Due to this movement, the sheet P or the sheet bundle PB is nipped between the upper and lower pressing plates 219 and 220 to subject the sheet P or the sheet bundle PB to folding.

The pressing guide rollers 211 and 212 connected to the moving plate 208 move on the pressing plates 219 and 220 together with movement of the moving plate 208 in the direction depicted by the arrow Q. By this movement, folding is proceeded toward the folded front end of the sheet bundle PB with a curved shape of the upper and lower pressing plates 219 and 220 rotatable or movable along grooves 221, 222, 223, and 224 (refer to FIG. 7) in side surfaces of the upper and lower pressing units 217 and 218.

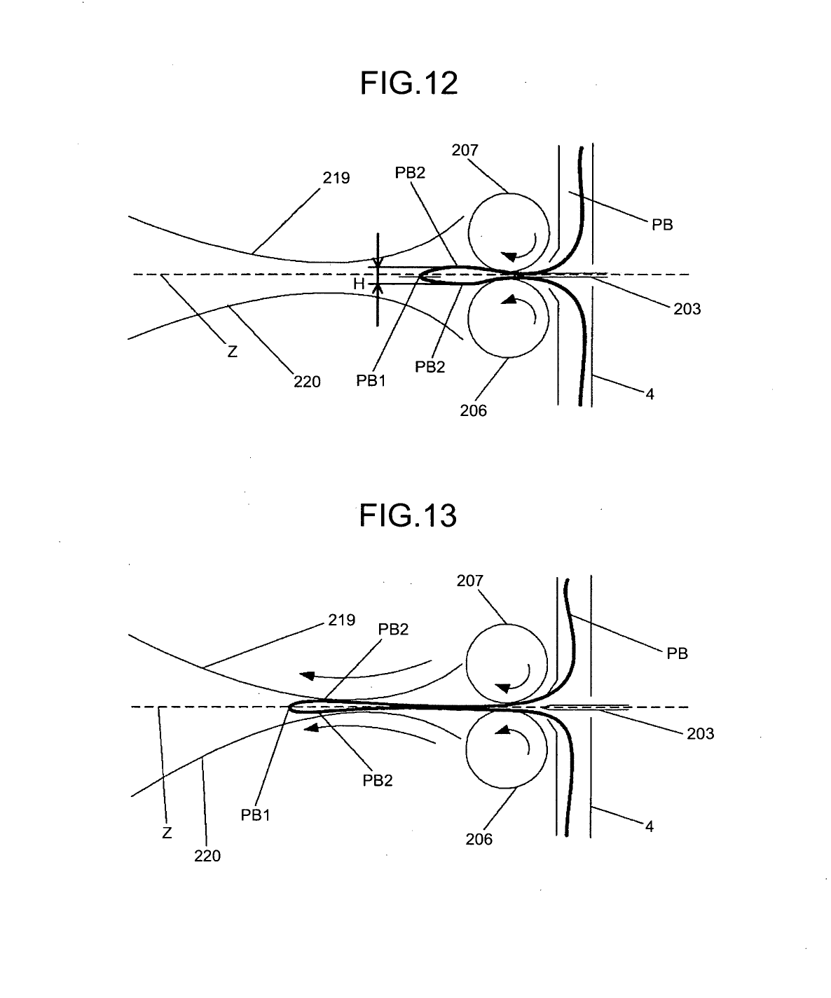

Incidentally, in the case of such a press-folding process, deflection may occur in the sheet bundle PB at a time of folding the sheet bundle. FIGS. 10 to 13 are diagrams illustrating a series of press-folding process and deflection occurring in the sheet bundle. The sheet bundle PB conveyed to an entrance of the nip portion between the pair of conveying rollers 206 and 207 of the center-folding unit 102 through the fourth conveying path 4 by the clamp moving fences 120 and 121 stops at a position where a position to be folded of the sheet bundle PB faces the folding blade 203 (FIG. 10), and the front end of the folding blade 203 comes into contact with the sheet bundle PB, so that the sheet bundle PB is pushed into a nip between the pair of conveying rollers 206 and 207 from a slit-like opening 4a of the fourth conveying path 4 (FIG. 11). The sheet bundle PB is conveyed into between the pressing plates 219 and 220 by the pair of conveying rollers 206 and 207 (FIGS. 12 and 13). At this time, since a front end PB1 of the sheet bundle PB is not creased, deflection PB2 occurs at the front end PB1 of the sheet bundle PB. When the height H of the deflection PB2 is large and deflection is not symmetrical in a vertical direction or the front end PB1 is deviated from a conveying center line Z during the folding process, which connects the nip of the conveying rollers 206 and 207 and a center of a gap between the pressing plates 219 and 220, the folded position at a time when folding the sheet bundle by the pressure applied from the pressing plates 219 and 220 may be deviated, which causes a deviation of the folded position or occurrence of a wrinkle. Furthermore, the opening 4a is formed at a position where the conveying center line Z is aligned with a center position of the opening 4a.

Hereinafter, examples of a process in which the deviation of the folding position or the wrinkle is prevented will be described as embodiments in detail.

### FIRST EMBODIMENT

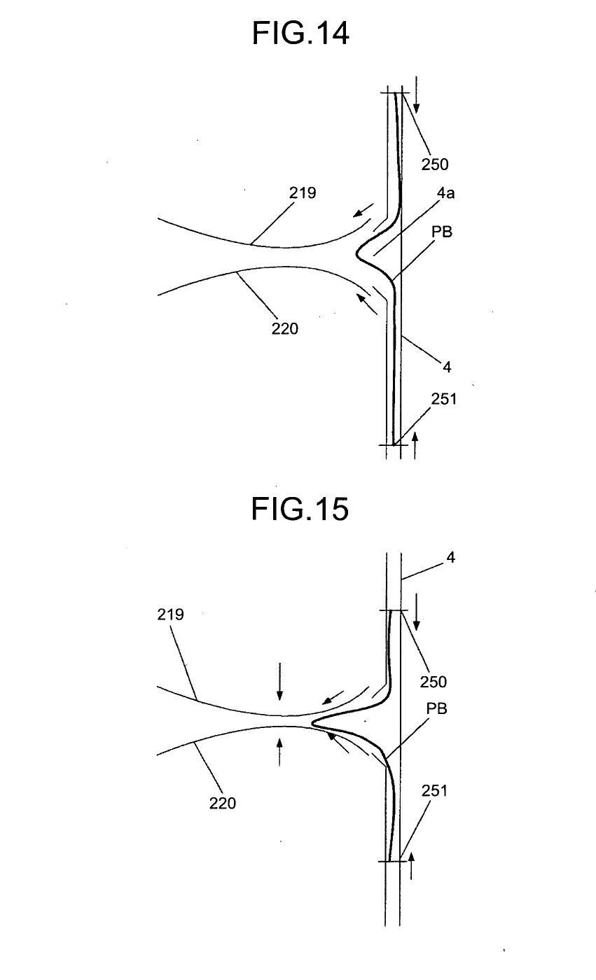

FIGS. 14 to 17 are diagrams illustrating an example of a process according to a first embodiment in which a sheet is nipped between stoppers to perform press-folding. The example of the process according to the first embodiment is an example in which the conveying roller and the folding blade are not used as a conveying instrument to convey the sheet bundle PB into between the pressing plates 219 and 220; but the sheet bundle PB is pressed from above and bellow by an upstream stopper 250 and a downstream stopper 251 in the conveying direction, which interpose the sheet bundle PB, so that the sheet bundle PB is bent and guided into between the pressing plates 219 and 220. That is, the rear end (corresponding to the rear end of the sheet when the sheet is conveyed into a creasing device) of the conveyed sheet bundle PB is brought into contact with the downstream stopper 251 in the conveying direction, and the position to be folded of the sheet bundle PB is positioned at the center of the gap between the pressing plates 219 and 220. Subsequently, the upstream stopper 250 in the conveying direction is brought into contact with the front end of the sheet bundle PB, and both stoppers 250 and 251 are moved close to each other.

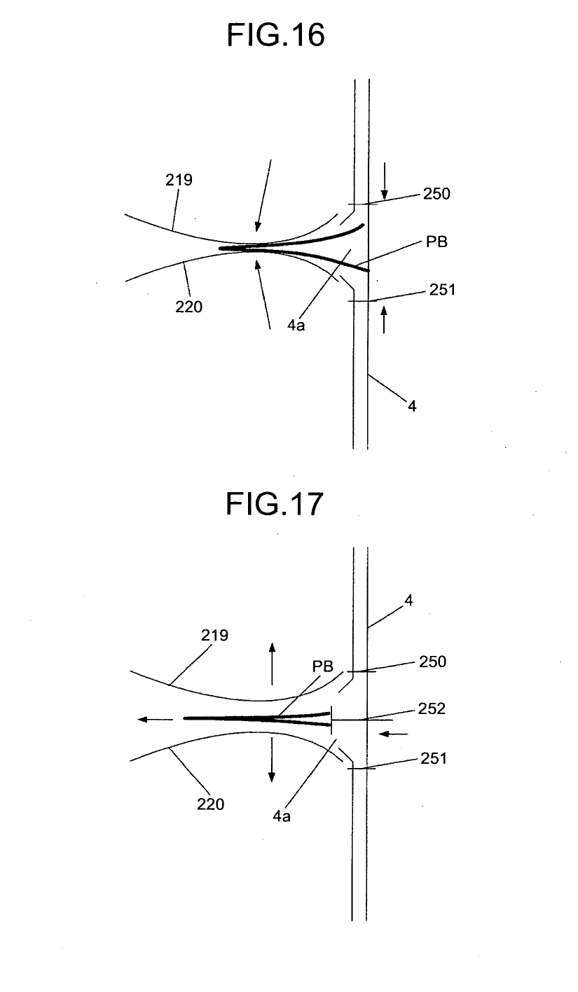

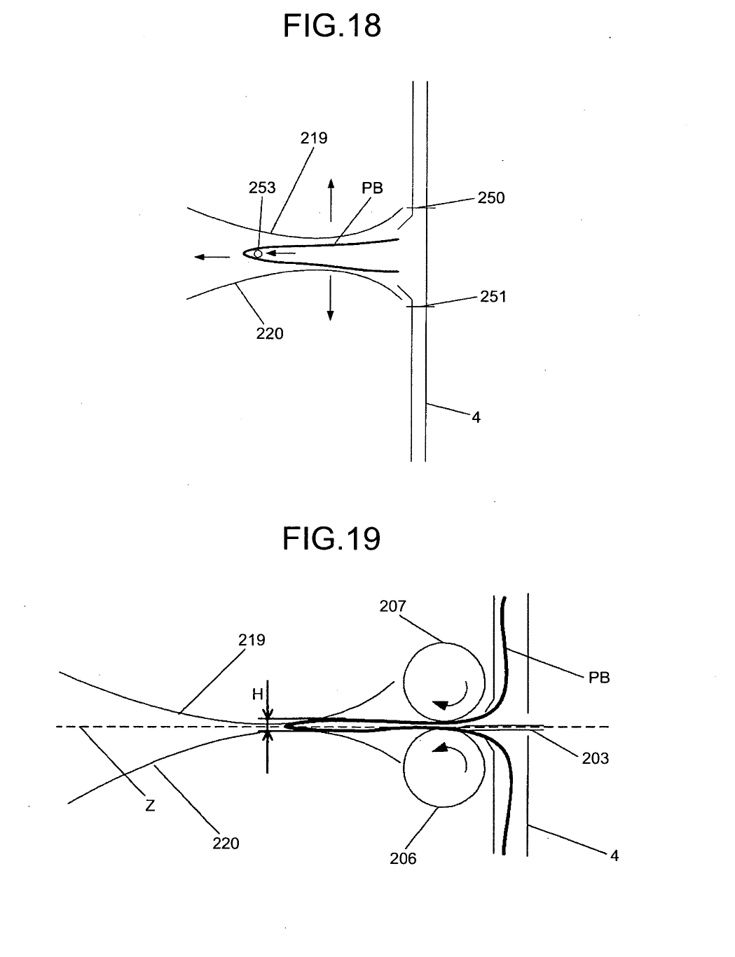

Then, the sheet bundle PB starts to be bent (FIG. 14), and is gradually pushed in between the pressing plates 219 and 220 from the opening 4a of the fourth conveying path 4 (FIG. 15). Therefore, when the gap between the pressing plates 219 and 220 is set to an appropriate gap depending on a thickness of the sheet bundle PB (FIG. 16), swelling of the deflection PB is suppressed. As a result, even when the pressure applied from the pressing plates 219 and 220 is released or the gap therebetween is widened, the center of the sheet bundle PB can be folded without swelling (FIG. 17). The press-folded sheet bundle PB is pushed from the backside of the sheet bundle PB by a push out bar 252 (FIG. 17). Alternatively, as shown in FIG. 18, an extracting bar 253 is inserted between folds of the sheet bundle PB to convey the sheet bundle by applying a conveying force from the backside of the front end PB1.

### SECOND EMBODIMENT

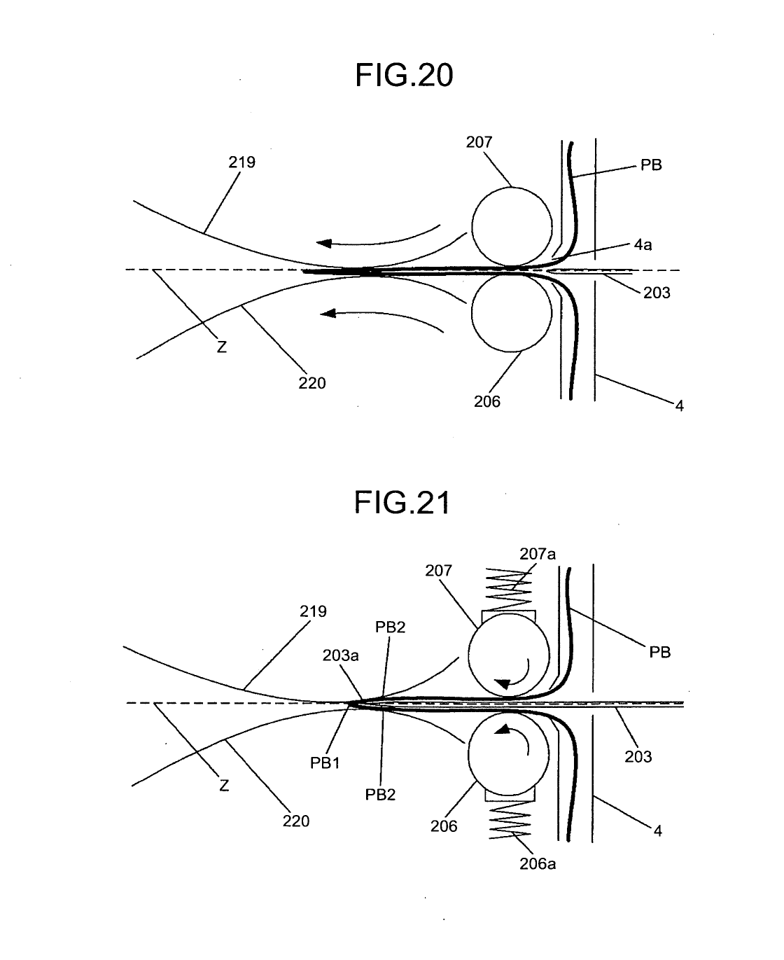

FIGS. 19 and 20 are diagrams illustrating an example of a process of a second embodiment in which the pair of conveying rollers 206 and 207, the folding blade 203, and the pressing plates 219 and 220 are used to perform press-folding process.

In the example shown in FIG. 12, the gap between the pressing plates 219 and 220 is set such that it is larger than the height of the deflection PB2 when the sheet bundle PB enters between the pressing plates 219 and 220, but is narrowed after the sheet bundle PB enters between the pressing plates 219 and 220 by applying pressure. On the other hand, in the present embodiment, as shown in FIG. 19, the gap between the pressing plates 219 and 220 is narrowed so as to limit (regulate) the height H of the deflection of the sheet bundle PB using the pressing plates 219 and 220 when the sheet bundle PB is conveyed into between the pressing plates 219 and 220 by the pair of conveying rollers 206 and 207. Accordingly, the deflection of the sheet bundle PB becomes smaller. When the deflection becomes smaller, as shown in FIG. 20, vertical asymmetry of the deflection or the deviation of the front end of the sheet bundle from the center line Z becomes smaller, so that the deviation of the folded position or the wrinkle can be reduced.

### THIRD EMBODIMENT

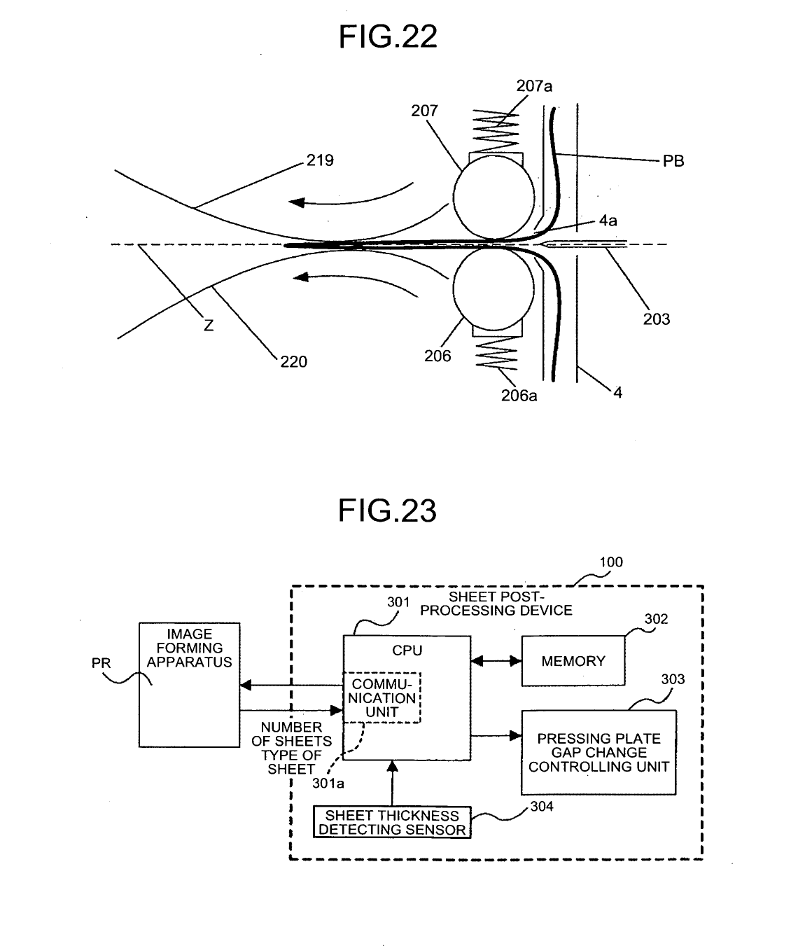

FIGS. 21 and 22 are diagrams illustrating an example of a process of a third embodiment in which the folding blade is inserted to the position of the pressing plates to perform a press-folding process.

In the example shown in FIG. 12, the folding blade 203 pushes the sheet bundle PB into a position before the nip of the pair of conveying rollers 206 and 207, and after the sheet bundle PB is nipped between the pair of conveying rollers 206 and 207, the sheet bundle PB is conveyed into between the pressing plates 219 and 220 by the conveying force of the pair of conveying rollers 206 and 207. On the other hand, in the present embodiment, the front end PB1 of the sheet bundle PB is inserted to a press position of the pressing plates 219 and 220 by the folding blade 203. That is, a front end 203a of the folding blade 203 comes into contact with the back surface of the sheet bundle PB to push the front end PB1 of the sheet bundle PB into the press position of the pressing plates 219 and 220.

When being pushed into the above-described position in this manner, since the folding blade 203 is located on the center line Z, the front end of the sheet bundle PB can be prevented from being deviated from the center line Z, and precision of the folded position can be further improved. In a case of such an operation, the folding blade 203 passes between the pair of conveying rollers 206 and 207 together with the sheet bundle PB, and occurrence of deflection in the sheet bundle PB is caused when the rotating speed of the pair of conveying rollers 206 and 207 is faster than the inserting speed of the folding blade 203. Therefore, in the present embodiment, in order to prevent such deflection, inserting speed of the folding blade 203 is set to be equal to rotating speed of the pair of conveying rollers 206 and 207. Then, when the pressing plates 219 and 220 perform folding action, the folding blade 203 is extracted from the sheet bundle PB. This is because the creasing degree is weak due to thickness of the folding blade 203 when the sheet bundle PB is folded with the folding blade 203 inserted therein.

The gap between the pair of conveying rollers 206 and 207 is made to be changed depending on the thickness of the sheet bundle. That is, when the sheet bundle PB is pushed by the folding blade 203 into a position of the pressing plates 219 and 220, the gap between the pair of conveying rollers 206 and 207 needs to be provided as much as an amount corresponding to the sum of the thickness of the folding blade 203 and the thickness of the sheet bundle. Although the sheet bundle PB is pushed downstream by the pair of conveying rollers 206 and 207 after the press-folding process is performed by the pressing plates 219 and 200, the inner surface of the sheet bundle PB is rubbed by the outer surface of the folding blade 203 when the folding blade 203 is present between the pair of conveying rollers 206 and 207, so that the inner surface of the sheet bundle PB gets dirty. For this reason, the folding blade 203 is returned upstream of the nip of the pair of conveying rollers 206 and 207 as shown in FIG. 12 and the like.

However, when the gap between the pair of conveying rollers 206 and 207 is wide, conveying (nipping) pressure is not sufficient in a case of a thin sheet bundle PB, so that the thin sheet bundle may not be discharged. On the other hand, when the gap between the pair of conveying rollers 206 and 207 is narrow, the nip of the pair of conveying rollers 206 and 207 generates resistance when pushing a thick sheet bundle by the folding blade 203, so that the sheet bundle PB may be broken or get dirty due to trace of the conveying rollers 206 and 207.

Therefore, in the present embodiment, compressing spring 206a and 207a are used to allow change of the gap between the pair of conveying rollers 206 and 207, and the pair of conveying rollers 206 and 207 are elastically biased in directions in which the conveying rollers 206 and 207 move close to each other with predetermined elastic force at all times. Accordingly, the pair of conveying rollers 206 and 207 moves close to or away from the center line Z depending on the thickness of the sheet bundle PB, and a predetermined nipping pressure can be maintained. As a result, the sheet bundle can be prevented from getting dirty due to the folding blade 203, and conveying performance of the sheet bundle PB can be maintained.

The thickness of the sheet bundle PB changes depending on the number of sheets and the thickness of the sheet. The gap between the pressing plates 219 and 220 needs to be widened in order to handle a thick sheet bundle, but deflection becomes larger in a case of a thin sheet bundle. Conversely, when the gap between the pressing plates 219 and 220 is narrowed in order to handle the thin sheet bundle PB, the thick sheet bundle PB may not enter between the pressing plates 219 and 220. Therefore, in the present embodiment, the gap between the pressing plates 219 and 220 is made to be changed depending on the thickness of the sheet bundle PB.

FIG. 23 is a block diagram illustrating a control configuration of the sheet post-processing device 100 that controls change of the gap between the pressing plates 219 and 220. In the same drawing, a control unit of the sheet post-processing device 100 includes a CPU 301, a memory 302, a pressing plate gap change controlling unit 303, and a sheet thickness detecting sensor 304. The CPU 301 includes a ROM and a RAM which are not shown in the drawings, a program stored on the ROM is developed on the RAM, and the control defined by the program is executed while the RAM is used as a work area and a data buffer. Furthermore, the memory 302 may be used as the RAM.

In the embodiment, the gap between the pressing plates 219 and 220 is changed and controlled in any one of the following manners 1) to 3):
1) A sheet thickness detecting sensor 304 is provided at an arbitrary position in the third conveying path 3 or the fourth conveying path 4 to detect the thickness of the sheet bundle PB. The CPU 301 reads out the gap between the pressing plates 219 and 220 corresponding to the thickness of the sheet bundle PB from the memory 302, which stores therein a relation between the thickness of the sheet bundle PB and the gap between the pressing plates as a table, in accordance with the detected thickness. The CPU 301 then instructs the pressing plate gap change controlling unit 303 so that the pressing plate gap change controlling unit 303 changes the gap between the pressing plates by controlling drive of a motor (not shown) driving the pressing plate driving cam 201 and the pressure releasing cams 209 and 210.
2) When the sheet P is conveyed to the sheet post-processing device 100, the number of the conveyed sheets P detected by the entrance sensor 13 is counted by the counter, the thickness of the sheet bundle PB is figured out on the basis of the thickness of one sheet recognized by the image forming apparatus PR and the number of sheets of one sheet bundle PB to be saddle-stitched, and the gap between the pressing plates is changed in the same manner as in 1).
3) Information on the number of sheets of the sheet bundle PB or a type of the sheet thereof is acquired from the image forming apparatus PR connected to the sheet post-processing device 100, and the gap between the pressing plates 219 and 220 is changed in accordance with the information in the same manner as in 1).

Furthermore, the control unit shown in FIG. 23 may be applied to the first embodiment and the second embodiment.

### FOURTH EMBODIMENT

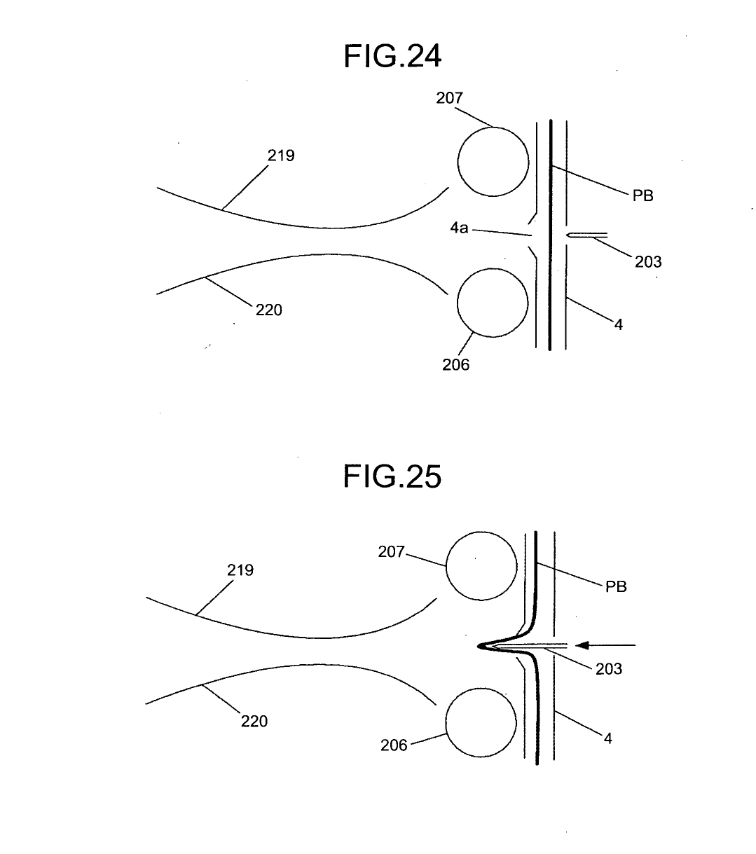

FIGS. 24 to 28 are diagrams illustrating an example of a process of a fourth embodiment in which the sheet bundle PB is pushed out by the folding blade 203 in a state where the conveying rollers 206 and 207 are moved away from each other, and the sheet bundle PB is nipped between the conveying rollers 206 and 207 and conveyed to the press position of the pressing plates 219 and 220 to perform press-folded.

The sheet bundle PB conveyed by the clamp moving fences 120 and 121 to the entrance of the nip of the pair of conveying rollers 206 and 207 of the center-folding unit 102 is stopped at a position where the position to be folded of the sheet bundle PB faces the folding blade 203 (FIG. 24), and the front end of the folding blade 203 comes into contact with the sheet bundle PB to push the sheet bundle PB from the opening 4a into between the pair of conveying rollers 206 and 207 (FIG. 25). At this time, the conveying rollers 206 and 207 move away to a position in which the conveying rollers 206 and 207 do not interfere with or contact the sheet bundle PB pushed by the folding blade 203.

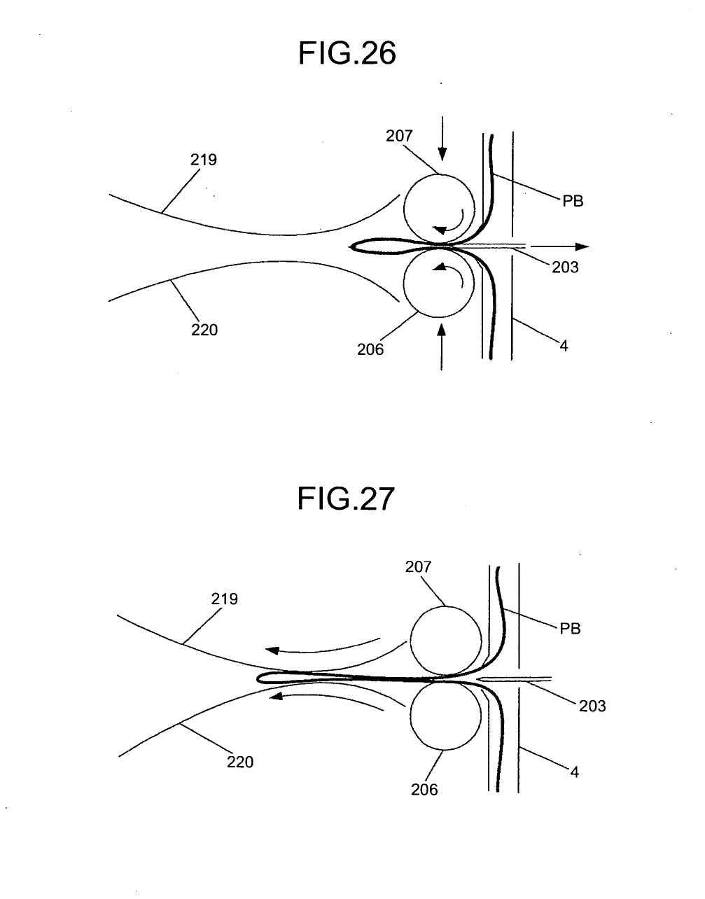

The sheet bundle PB is further pushed by the folding blade 203 to be conveyed into between the pressing plates 219 and 220. When the front end of the sheet bundle PB exits the pair of conveying rollers 206 and 207, the sheet bundle PB is nipped and conveyed by a pair of conveying rollers 206 and 207 (FIG. 26). Whether the front end of the sheet bundle PB exits the pair of conveying rollers 206 and 207 is detected by a sheet detecting sensor (not shown) provided between a position of the pressing plates 219 and 220 and a position of the conveying rollers 206 and 207. Incidentally, instead of the sheet detecting sensor, for example, a method may be employed in which a moving amount of the folding blade 203 is detected or a rotating amount of the motor driving the folding blade 203 is measured, and the moving amount of the folding blade 203 or the rotating amount is converted into a moving amount of the sheet bundle PB.

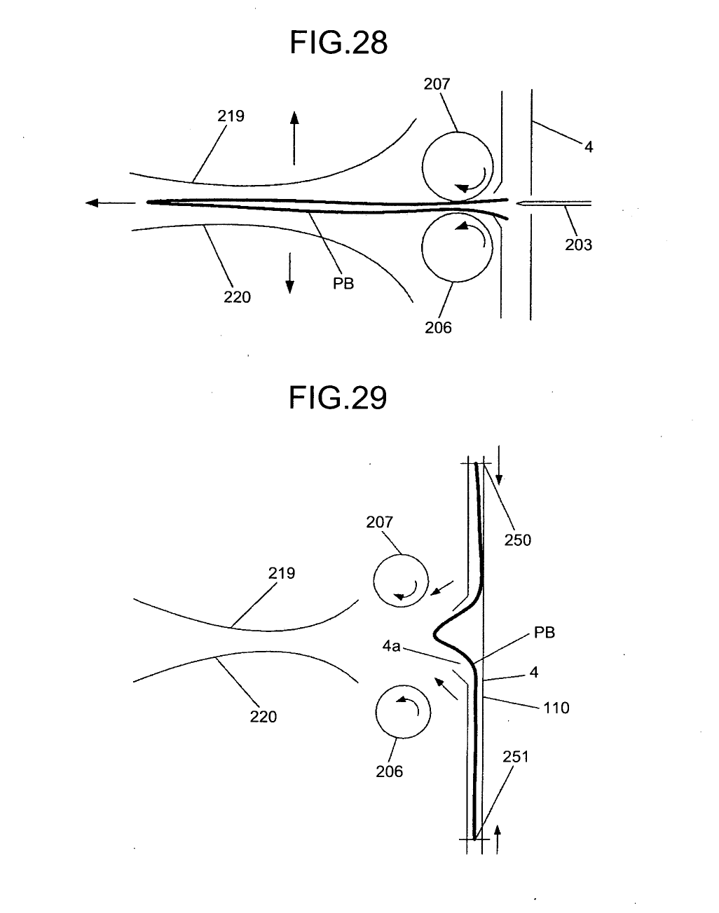

When the front end of the sheet bundle PB reaches between the pressing plates 219 and 220, rotation of the conveying rollers 206 and 207 is stopped and movement of the sheet bundle PB is stopped. Then, the sheet bundle PB is nipped and folded while a nip position of the pressing plates 219 and 220 is gradually changed from a position closer to the conveying rollers 206 and 207 to the front end of the sheet bundle PB (FIG. 27). After the folding process is performed, the pressing plates 219 and 220 are opened, and the conveying rollers 206 and 207 and the discharging roller 58 are rotationally driven to discharge the sheet bundle PB (FIG. 28).

### FIFTH EMBODIMENT

FIGS. 29 to 32 are diagrams illustrating an example of a process of a fifth embodiment in which the sheet bundle is interposed between the stoppers to locate the sheet bundle between the pair of separated conveying rollers and is then press-folded in the same manner as in the fourth embodiment.

In the example of the process of the fifth embodiment, the folding blade is not used as a conveying instrument to convey the sheet bundle PB into between the pressing plates 219 and 220 and the sheet bundle PB is interposed between the upstream stopper 250 and the downstream stopper 251 in the conveying direction and is pressed from above and below so as to be bent to be guided into between the conveying rollers 206 and 207 from the opening 4a. The present embodiment is different from the first embodiment in that the conveying rollers 206 and 207 are provided and the sheet bundle is conveyed from a position of the conveying rollers 206 and 207 into between the pressing plates 219 and 220 using the conveying rollers 206 and 207.

That is, as in the first embodiment, when press of the sheet bundle PB by the stoppers 250 and 251 proceeds, the sheet bundle PB starts to be folded at the center thereof. At this time, the positions of the stoppers 250 and 251 are controlled so as to be vertically symmetrical to each other with respect to the center of the sheet bundle PB. When the positions of the stoppers are not symmetrical to each other vertically, deflection is deviated from the center position of the sheet bundle PB (which is equal to the center line Z shown in FIG. 19 and the like), so that the folding process may not be performed at a correct position when the sheet bundle is pressed by the pressing plates 219 and 220. Further, also when the deflection becomes larger, the center position of the sheet bundle PB is easily deviated. Accordingly, the gap between the pressing plates 219 and 220 is set to an appropriate value so that the deflection does not increase.

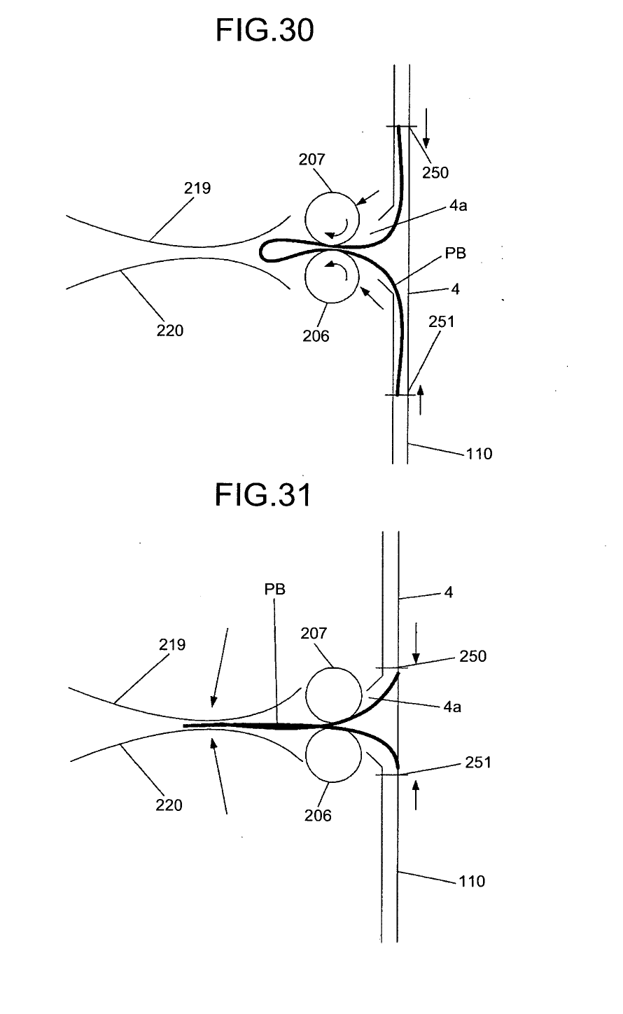

When press of the sheet bundle PB by the stoppers 250 and 251 further proceeds, the sheet bundle is extruded from the opening 4a in the fourth conveying path 4 toward the conveying rollers 206 and 207 (FIG. 29). The sheet bundle PB is extruded into between the pressing plates 219 and 220 by the stoppers 250 and 251, and the sheet bundle P is nipped between the conveying rollers 206 and 207 and conveyed after the front end PB1 of the sheet bundle passes between the conveying rollers 206 and 207 (FIG. 30).

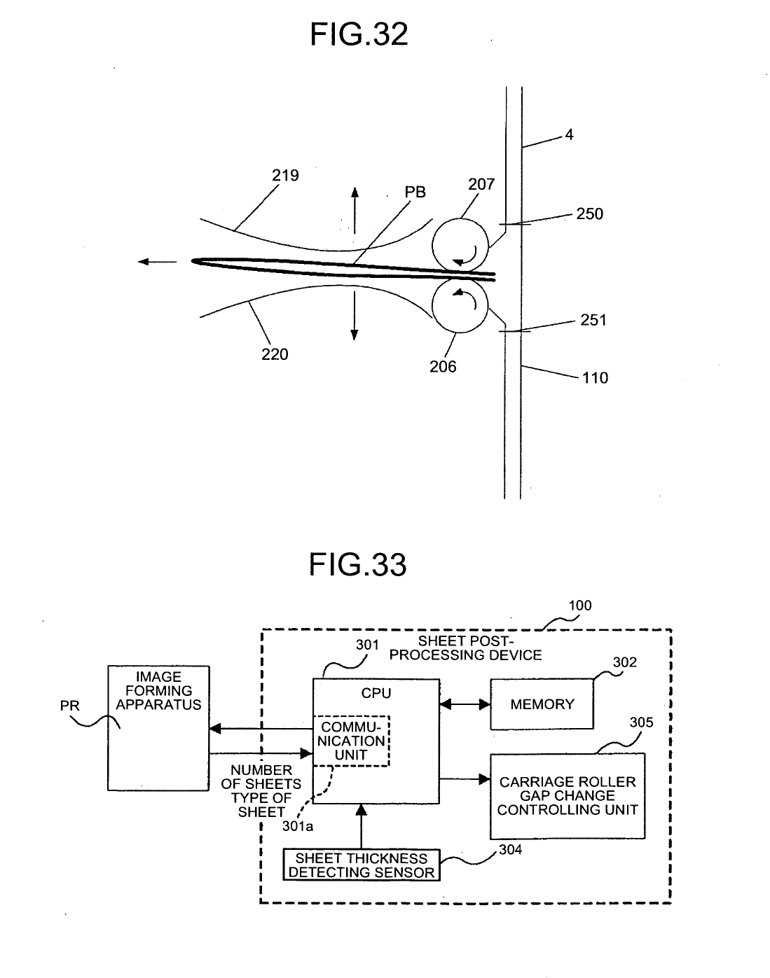

When the front end PB1 of the sheet bundle PB reaches between the pressing plates 219 and 220, rotation of the conveying rollers 206 and 207 is stopped so that movement of the sheet bundle PB is stopped. Then, the pressing guide rollers 211 and 212 facing back surfaces of the pressing plates 219 and 220, respectively, are moved from a position closer to the conveying rollers 206 and 207 to the front end of the sheet bundle PB to press the sheet bundle PB between the pressing plates 219 and 220 to perform press-folding (FIG. 31). After folding is performed, the pressing plates 219 and 220 are opened and the conveying rollers 206 and 207 and the discharging roller 58 are rotated to discharge the sheet bundle PB (FIG. 32).

In the fifth embodiment, since the sheet bundle is conveyed by the conveying rollers 206 and 207, the sheet bundle PB may be more reliably and stably sent into between the pressing plates 219 and 220 compared to the first embodiment.

The thickness of the sheet bundle PB changes depending on the number of sheets and the thickness of the sheet. The gap between the conveying rollers 206 and 207 needs to be widened when conveying the sheet bundle in order to handle the thick sheet bundle PB, but the thin sheet bundle PB may not be conveyed when the gap between the conveying rollers 206 and 207 is widened. Conversely, when the gap between the conveying rollers 206 and 207 is narrowed in order to handle the thin sheet bundle PB, the thick sheet bundle PB may not enter between the conveying rollers 206 and 207 or load of the conveying rollers 206 and 207 becomes larger, so that a problem that folding become impossible to perform, the sheet bundle is damaged, or the power consumption of the sheet bundle driving motor increases may be occur. Therefore, in the embodiment, the gap between the conveying rollers 206 and 207 is made to be changed depending on the thickness of the sheet bundle PB.

FIG. 33 is a block diagram illustrating a control configuration of the sheet post-processing device 100 that controls change of the gap between the conveying rollers 206 and 207. This control configuration is different from the control configuration of changing the gap between the pressing plates 219 and 220 shown in FIG. 23 in that the pressing plate gap change controlling unit 303 is replaced by a conveying roller gap change controlling unit 305, and the other configurations are the same as those of the respective units of FIG. 23.

Incidentally, the mechanism moving the conveying rollers 206 and 207 close to or away from each other is not particularly shown, but a configuration may be adopted in which conveying roller shafts 206a and 207a shown in FIG. 5 or 8 are supported to be movable close to or away from each other, a distance between the conveying roller shafts 206a and 207a is set by driving a cam mechanism using a motor controlled to be driven by the conveying roller gap change controlling unit 305, and power to drive the conveying rollers 206 and 207 is transmitted from a motor (not shown) by a power transmitting mechanism. Since these mechanisms are generally used as a mechanism system of a conveying mechanism, explanation of the mechanisms is omitted herein.

In a case that the control system is configured as illustrated in FIG. 33, any one of the following processes 1) to 3) may be employed.
1) The sheet thickness detecting sensor 304 is provided at an arbitrary position in the third conveying path 3 or the fourth conveying path 4 to detect the thickness of the sheet bundle PB, the CPU 301 reads out the gap between the conveying rollers 206 and 207 corresponding to the thickness of the sheet bundle PB from the memory 302, which stores therein a relation between the thickness of the sheet bundle PB and the gap between the pressing plates as a table, in accordance with the detected thickness, and the CPU 301 instructs the conveying roller gap change controlling unit 305 so that the conveying roller gap change controlling unit 305 changes the gap between the conveying rollers 206 and 207 by controlling drive of a motor (not shown) driving a cam setting the gap between the conveying rollers 206 and 207.
2) When the sheet P is conveyed to the sheet post-processing device 100, the number of the conveyed sheets P detected by the entrance sensor 13 is counted by the counter, the thickness of the sheet bundle PB is figured out on the basis of the thickness of one sheet recognized by the image forming apparatus PR and the number of sheets of one sheet bundle PB to be stitched, and the gap between the conveying rollers 206 and 207 is changed in the same manner as in 1).
3) Information on the number of sheets of the sheet bundle PB or the type of the sheet thereof is acquired from the image forming apparatus PR connected to the sheet post-processing device 100, and the gap between the conveying rollers 206 and 207 is changed in accordance with the information in the same manner as in 1).

Furthermore, the gap between the pressing plates 219 and 220 and the gap between the conveying rollers 206 and 207 may be controlled to be changed by a combination of the third embodiment and the fifth embodiment.

As described above, according to the embodiment, various advantageous effects including the following advantageous effects 1) to 8) can be obtained.
1) In an aspect in which the gap between the pressing plates 219 and 220 is changed so as to regulate the deflection PB2 of the sheet bundle from when the sheet bundle is conveyed between the pressing plates 219 and 220 until the sheet bundle is folded at the center thereof by the pressing plates 219 and 220, the precision of the position folded by the pressing plates 219 and 220 can be improved, wrinkles can be prevented, and a height of the folded sheet or sheet bundle can be reduced by reliably creasing the sheet or sheet bundle.
2) In an aspect in which the gap of the conveying rollers 206 and 207 are widened until the front end PB1 of the sheet bundle PB passes the gap, the sheet bundle is not creased by the conveying rollers 206 and 207 and occurrence of folding into a box-like configuration and a folding position error can be prevented. As a result, a deviation in folded position and occurrence of wrinkles can be prevented and a height of the folded sheet or sheet bundle can be reduced by reliably creasing the sheet or sheet bundle.
3) In an aspect in which the sheet bundle PB is pushed into between the conveying rollers 206 and 207 and/or the pressing plates 219 and 200 by the folding blade 203, the precision of the folding position can be improved.
4) In an aspect in which the thickness of the sheet bundle PB is detected and the gap between the pressing plates 219 and 200 or the gap between the conveying rollers 206 and 207 is controlled depending on the thickness of the sheet bundle PB, deflection can be suppressed even when the thickness of the sheet bundle PB is different, so that the precision of the folded position can be improved, and occurrence of wrinkles can be prevented.
5) In an aspect in which the number of sheets of the sheet bundle PB is counted and the gap between the pressing plates 219 and 220 or the gap between the conveying rollers 206 and 207 is controlled depending on the number of sheets of the sheet bundle PB, deflection can be suppressed even when the thickness of the sheet bundle PB is different, so that the precision of the folded position can be improved, and occurrence of wrinkles can be prevented. At this time, since the detection sensor detecting the thickness of the sheet bundle PB is not needed, cost can be reduced.
6) In an aspect in which the gap between the pressing plates 219 and 220 or the gap between the conveying rollers 206 and 207 is controlled on the basis of information on the number of sheets and/or the type of the sheet received from an external apparatus, for example, an image forming apparatus, deflection can be suppressed even when the thickness of the sheet bundle PB is different, so that the precision of the folded position can be improved, and occurrence of wrinkles can be prevented. At this time, since the detection sensor detecting the thickness of the sheet bundle PB or the counter is not needed, cost can be reduced.
7) In an aspect in which the gap between the conveying rollers 206 and 207 is controlled on the basis of the thickness of the folding blade 203 and the sheet bundle, a conveying error can be prevented and the sheet bundle can be prevented from getting dirty during the center-folding process.
8) In an aspect in which the conveying speed of the conveying rollers 206 and 207 is set to be equal to the speed of the folding blade 203 during pushing, deflection caused by a difference in speed therebetween can be prevented and the sheet bundle can be prevented from getting dirty due to rubbing.

According to an aspect of the invention, since a gap between two members is controlled to be changed depending on the thickness of the sheet or the sheet bundle while the sheet or the sheet bundle is guided into between the two members, a deviation in folded position and occurrence of wrinkles can be prevented and the height of the folded sheet or sheet bundle can be reduced by reliably creasing the sheet or the sheet bundle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet folding device comprising:
a guide unit that bends a sheet or a sheet bundle in a direction perpendicular to a conveying direction and guides a bent portion into between two members facing each other;
a press-folding unit that presses to fold the bent portion; and
a change controlling unit that performs control of changing a gap between the two members depending on a thickness of the sheet or the sheet bundle when the sheet or the sheet bundle is guided into between the two members.

2. The sheet folding device according to claim 1,
wherein the two members are a pair of pressing plates, and the press-folding unit presses the pressing plates, and
wherein the change controlling unit performs control of changing a gap between the pressing plates since the sheet or the sheet bundle is conveyed into between the pressing plates until a center-folding process is performed by the pressing plates.

3. The sheet folding device according to claim 1,
wherein the two members is a pair of conveying rollers, and
wherein the change controlling unit performs control of changing a gap between the pair of conveying rollers since a front end of the sheet or the sheet bundle passes between the pair of conveying rollers until the sheet or the sheet bundle is nipped between the conveying rollers so that the sheet bundle is conveyed.

4. The sheet folding device according to claim 1,
wherein the guide unit is a folding blade that pushes the sheet or the sheet bundle in a direction perpendicular to the conveying direction.

5. The sheet folding device according to claim 4,
wherein the folding blade pushes the sheet or the sheet bundle into a position where a folding process is performed by the press-folding unit.

6. The sheet folding device according to claim 1,
wherein the guide unit is stoppers that press the sheet or the sheet bundle toward a center thereof from upstream and downstream in the conveying direction.

7. The sheet folding device according to claim 1, further comprising:
a thickness detecting unit that detects the thickness of the sheet or the sheet bundle,
wherein the change controlling unit changes the gap between the two members on the basis of a detection result of the thickness detecting unit.

8. The sheet folding device according to claim 1, further comprising:
a counting unit that counts number of sheets of the sheet bundle,
wherein the change controlling unit changes the gap between the two members on the basis of a count result of the counting unit.

9. The sheet folding device according to claim. 3,
wherein the guide unit is a folding blade that pushes the sheet or the sheet bundle in a direction perpendicular to the conveying direction, and
wherein a conveying speed of the pair of conveying rollers is equal to a moving speed of the folding blade.

10. The sheet folding device according to claim 3, further comprising:
a thickness detecting unit that detects the thickness of the sheet or the sheet bundle,
wherein the guide unit is a folding blade that pushes the sheet or the sheet bundle in a direction perpendicular to the conveying direction, and
wherein the change controlling unit changes the gap between the two members on the basis of a detection result of the thickness detecting unit and a thickness of the folding blade.

11. The sheet folding device according to claim 1, further comprising:
a communication unit that receives information on number of sheets of the sheet bundle and/or a type of the sheet from an external apparatus,
wherein the change controlling unit changes the gap between the two members on the basis of the information on the number of sheets of the sheet bundle and/or the type of the sheet received by the communication unit.

12. The sheet folding device according to claim 11,
wherein the external apparatus is an image forming apparatus.

13. A sheet processing device comprising:
the sheet folding device according to claim 1.

14. An image forming apparatus comprising:
the sheet processing device according to claim 13.

15. A sheet folding method comprising:
bending a sheet or a sheet bundle in a direction perpendicular to a conveying direction and guiding the bent portion into between two members facing each other;
presses to fold the bent portion; and
performing control of changing a gap between the two members depending on a thickness of the sheet or the sheet bundle in order to suppress deflection of the bent portion when the sheet or the sheet bundle is guided into between the two members.
